(19) United States
(12) Patent Application Publication
(10) Pub. No.: US 2011/0114689 A1
(43) Pub. Date: May 19, 2011

(54) Parallelepiped tape cutter

(76) Inventor: Yu Chin Liu, Taichung (TW)

(21) Appl. No.: 12/824,229

(22) Filed: Jun. 28, 2010

(30) Foreign Application Priority Data
Nov. 16, 2009 (TW) 098221278

(51) Int. Cl. B65H 75/02; B26F 3/02

(52) U.S. Cl. 225/39; 225/91

(57) ABSTRACT

A parallelepiped tape cutter includes a cover comprising a top, two sides, a bottom flange, a blade at an open end of one side, a latching element on the other side, a concave member on an inner surface of the latching element, and a limit member on an inner surface of the other side adjacent to one end of the concave member; a support comprising a recessed rail on either side of a raised bottom, a bent first wall, a bent second wall separate from the first wall, a latch projecting out of one end of the second wall toward the first wall, the latch having a laterally protruded latching end proximate to one end of the first wall, a slit at the other end of the first wall, and an opening defined between the second wall and the slit; and a tape roll in the support.

### BACKGROUND OF THE INVENTION

1. Field of Invention

The invention relates to adhesive tape dispensers and more particularly to a parallelepiped tape cutter with improved characteristics.

2. Description of Related Art

There are various tape cutters are commercially available. For example, a conventional tape cutter comprises an applying member having a buffing surface, a blade movable to and out of a serving position relative to the buffing surface, a guide member for positioning the blade adjacent to the buffing surface, a guard member movable relative to the buffing surface to an operative position adjacent to the buffing surface to expose the buffing surface to an adjacent tape receiving surface from a normal position spaced from the buffing surface when the buffing surface is spaced from the receiving surface, and a coupling member for connecting the blade to the guard member to move the blade in the guide member from the severing position when the guard member is moved to the operative position adjacent to the buffing surface and to the severing position when the guard member is returned to the normal position.

However, the conventional tape cutter suffers from a number of disadvantages. For example, it has many components which in turn can increase the manufacturing cost greatly. Further, a replacement of an empty tape roll is relatively difficult due to complicated structure. Moreover, the tape cutter may be damaged if sufficient care is not taken during the tape roll replacement. Thus, the need for improvement still exists.

### SUMMARY OF THE INVENTION

It is therefore one object of the invention to provide a parallelepiped tape cutter comprising a cover open to front and bottom and comprising a top, two sides, a U shaped bottom flange, a blade at an open end of one side, a flexible latching element on the other side, a concave member on an inner surface of the latching element, and a projecting limit member on an inner surface of the other side adjacent to one end of the concave member; a support comprising a recessed rail on either side of a raised bottom, a bent first wall, a bent second wall separate from the first wall, a latch projecting out of one end of the second wall toward one end of the first wall, the latch having a laterally protruded latching end proximate to one end of the first wall, a slit at the other end of the first wall, an opening defined between the other end of the second wall and the slit, and an annular flexible tape mount integrally formed on the bottom; and a tape roll releasably mounted on the tape mount, wherein in a normal position, the support is received in the cover with the latching end lockingly engaged with the other end of the concave member, one end of the tape roll passing the slit to suspend in the opening, and the flange disposed on the recessed rails; and whereby pulling the support with the flange sliding along the recessed rails until the latching end is stopped by the limit member will expose one end of the tape roll in an operative position, and after pulling one end of the tape roll a distance sliding the support into the cover will cause the blade to sever the tape roll by cooperating with the other end of the second wall and return the support to the normal position.

The above and other objects, features and advantages of the invention will become apparent from the following detailed description taken with the accompanying drawings.

### BRIEF DESCRIPTION OF THE DRAWINGS

FIGS. 1 and 2 are two exploded views of a parallelepiped tape cutter according to the invention viewed from two opposite angles respectively;

FIGS. 3 and 4 are perspective views of the assembled tape cutter corresponding to FIGS. 1 and 3 respectively;

FIG. 5 is a cross-sectional view of the tape cutter in FIG. 3;

FIG. 6 is a perspective view of the tape cutter with the sliding support being partially pulled out of its closed position;

FIG. 7 is a perspective view of the tape cutter in FIG. 6 but viewed from an opposite angle;

FIG. 8 is cross-sectional view of the tape cutter in FIG. 7;

FIG. 9 is a view similar to FIG. 8 showing a pulling of the adhesive tape for dispensing purpose; and

FIG. 10 is a view similar to FIG. 5 showing the remaining adhesive tape in a position after severing.

### DETAILED DESCRIPTION OF THE INVENTION

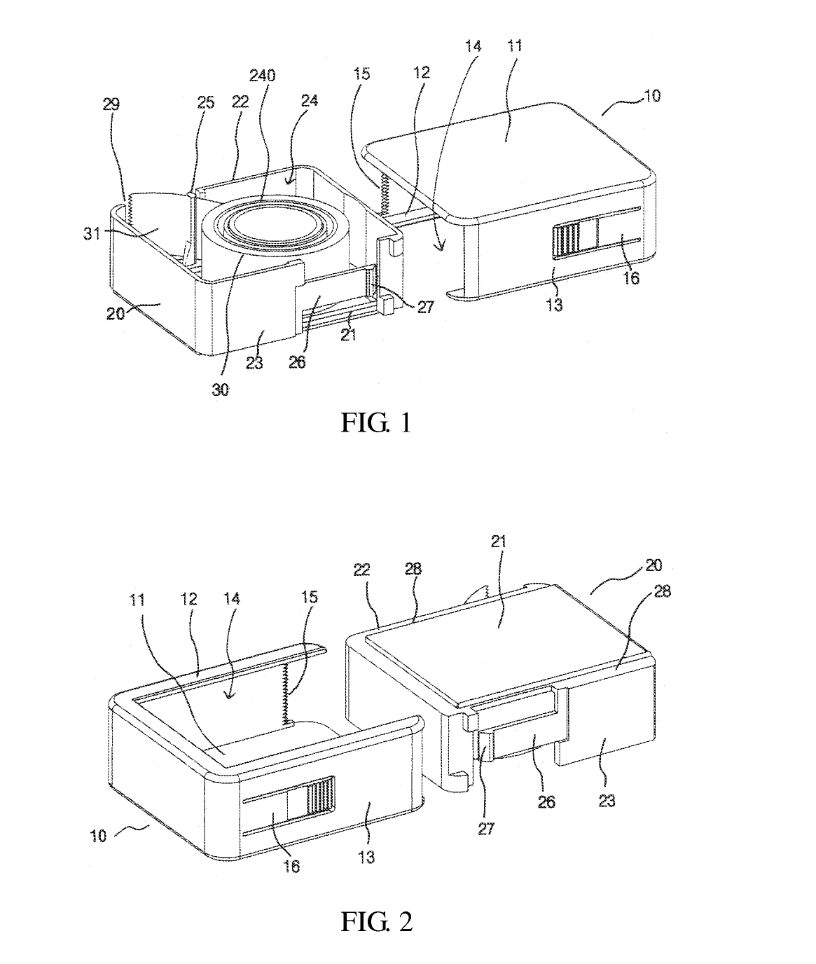

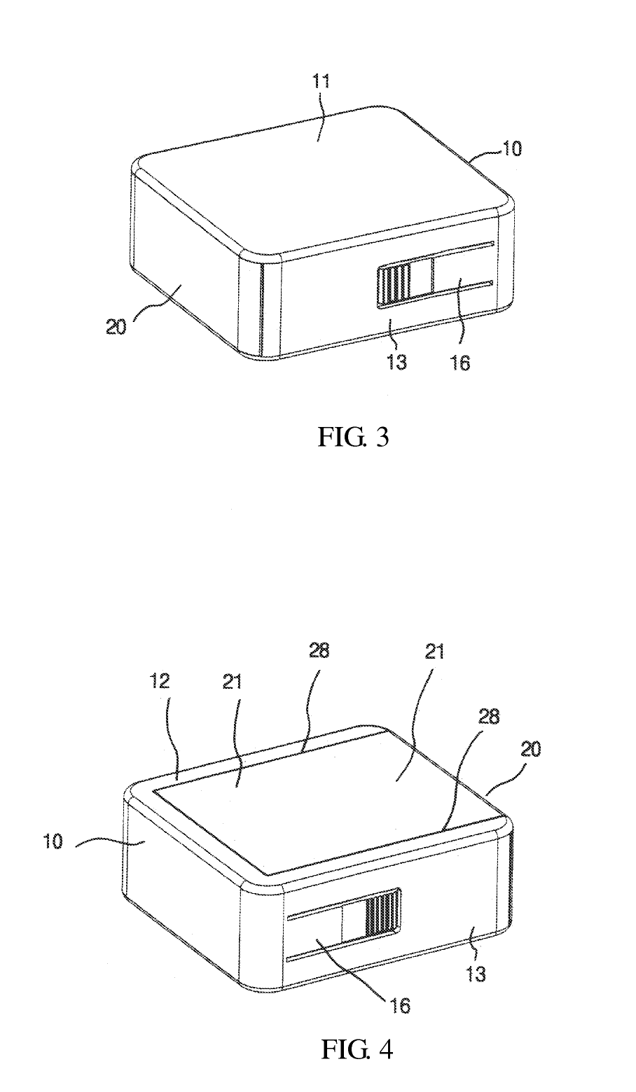

Referring to FIGS. 1 to 10, a parallelepiped tape cutter in accordance with the invention comprises the following components as discussed in detail below.

A cover 10 is a rectangular hollow body and comprises a top 11, two sides 13, a U shaped flange 12 extending inward along bottom edge, an internal space 14 open to front and bottom, a cutting member (i.e., toothed blade) 15 at an open end of one side 13, and a flexible latching element 16 on the other side 13. On an inner surface of the latching element 16 there is provided a concave member 18. Also, a projecting limit member 17 is provided on an inner surface of the other side 13 adjacent to one of two projecting edges of the concave member 18.

A sliding support 20 is also a rectangular hollow body and is adapted to releasably dispose in the cover 10. The sliding support 20 comprises a raised bottom plate 21 having a recessed rail 28 on either side, a bent first wall 22, a bent second wall 23 separate from the first wall 22, a latch 26 projecting out of one end of the second wall 23 toward the first wall 22, the latch 26 having a laterally protruded latching end 27 proximate to one end of the first wall 22, a slit 25 at the other end of the first wall 22, an opening 29 defined between the other end of the second wall 23 and the slit 25, an internal space 24, and an annular flexible tape mount 240 integrally formed on the bottom plate 21 in the space 24.

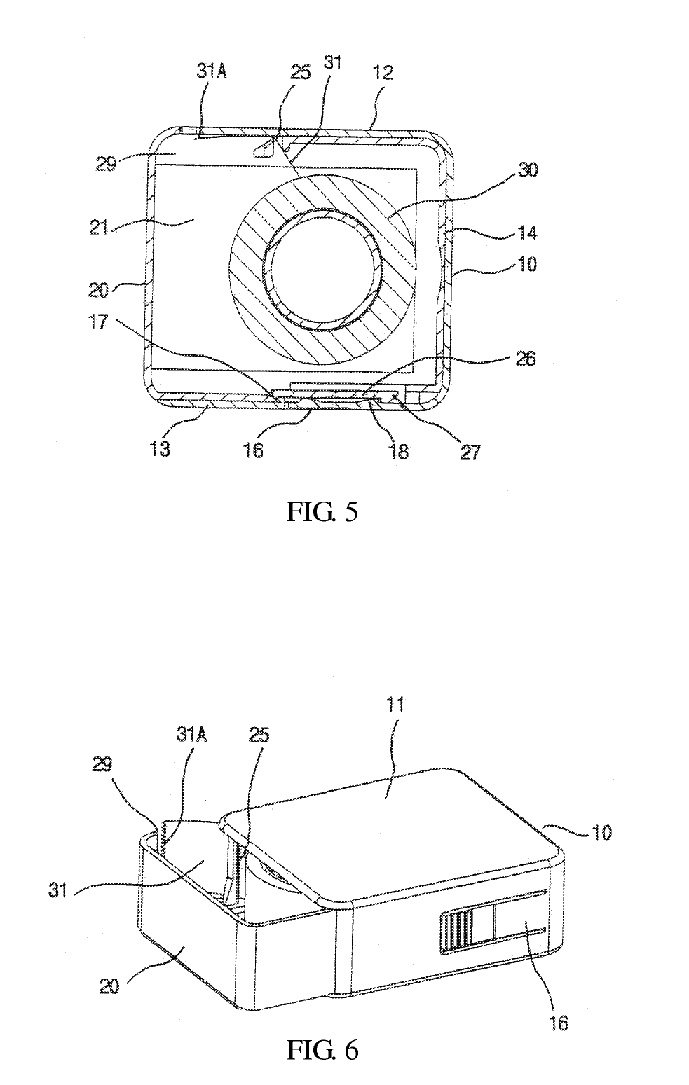

A tape roll 30 with wound adhesive tape 31 is releasably mounted on the tape mount 240 and has one end 31A pulled out of the slit 25 a short distance to suspend in the opening 29 in a ready to use position (see FIG. 5).

In a normal position of the tape cutter (i.e., inoperative position), the sliding support 20 is received in the cover 10 with the latching end 27 lockingly engaged with the other projecting edge of the concave member 18 (see FIG. 5) and one end 31A of the adhesive tape 31 suspended in the opening 29.

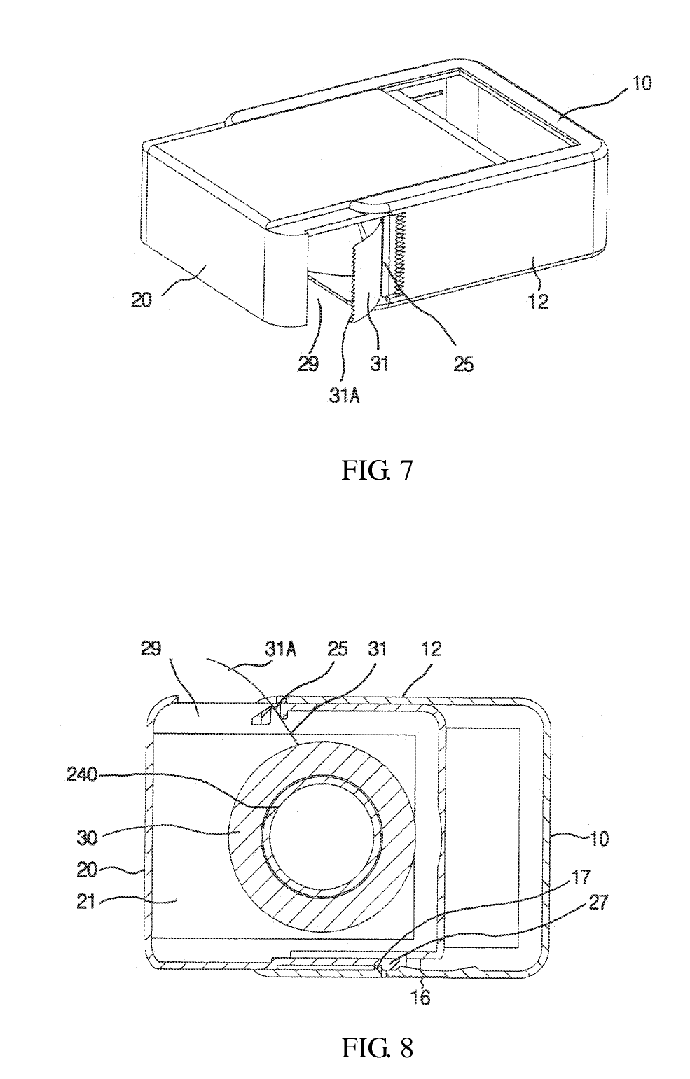

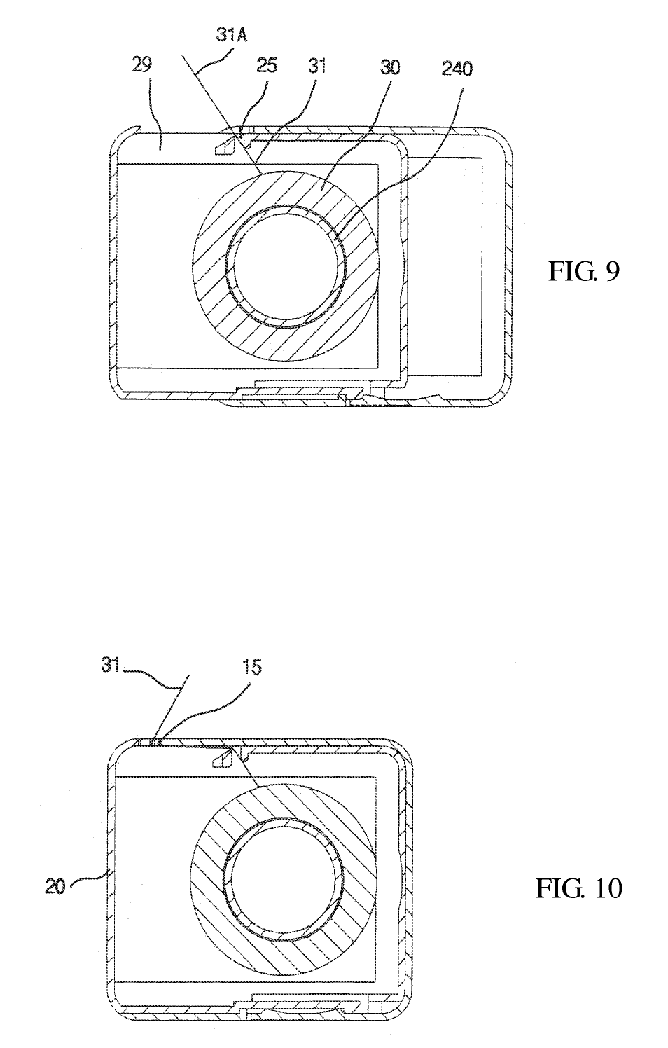

For using the adhesive tape 31, an individual may pull the sliding support 20 with the flange 12 sliding along the recessed rails 28 until the latching end 27 is stopped by the limit member 17 (see FIGS. 7 and 8). Also, the end portion including one end 31A of the adhesive tape 31 is exposed and disposed externally of the opening 29 due to the elasticity of the adhesive tape 31. Thereafter, the individual may use fingers to hold one end 31A of the adhesive tape 31 and pull same until a desired length of the adhesive tape 31 is drawn out of the tape cutter (see FIG. 9). Next, the individual may slide the support 20 into the cover 10 to cause the cutting member 15 to tightly engage with the other end of the second wall 23 to sever the adhesive tape 31. At this position, the latching end 27 is lockingly engaged with the other projecting edge of the concave member 18 (see FIG. 10). The tape cutter is disposed in a normal position again.

An individual may use a finger or a sharp object to push the latching end 27 inward and pull the support 20 until the support 20 and the cover 10 are completely separate. Thereafter, a replacement of the empty tape roll 30 can be made easily.

While the invention has been described in terms of preferred embodiments, those skilled in the art will recognize that the invention can be practiced with modifications within the spirit and scope of the appended claims.

What is claimed is:

1. A parallelepiped tape cutter comprising:
a cover open to front and bottom and comprising a top, two sides, a U shaped bottom flange, a blade at an open end of one side, a flexible latching element on the other side, a concave member on an inner surface of the latching element, and a projecting limit member on an inner surface of the other side adjacent to one end of the concave member;
a support comprising a recessed rail on either side of a raised bottom, a bent first wall, a bent second wall separate from the first wall, a latch projecting out of one end of the second wall toward one end of the first wall, the latch having a laterally protruded latching end proximate to one end of the first wall, a slit at the other end of the first wall, an opening defined between the other end of the second wall and the slit, and an annular flexible tape mount integrally formed on the bottom; and
a tape roll having a wound adhesive tape releasably mounted on the tape mount,
wherein in a normal position, the support is received in the cover with the latching end lockingly engaged with the other end of the concave member, one end of the adhesive tape passing the slit to suspend in the opening, and the flange disposed on the recessed rails; and
whereby pulling the support with the flange sliding along the recessed rails until the latching end is stopped by the limit member will expose one end of the adhesive tape in an operative position, and after pulling one end of the adhesive tape a distance sliding the support into the cover will cause the blade to sever the adhesive tape by cooperating with the other end of the second wall and return the support to the normal position.

2. The parallelepiped tape cutter of claim 1, wherein the blade is toothed.
